(19) United States
(12) Patent Application Publication
(10) Pub. No.: US 2014/0313769 A1
(43) Pub. Date: Oct. 23, 2014

(54) BACKLIGHT MODULE HAVING POINT LIGHT SOURCES

(71) Applicant: HON HAI PRECISION INDUSTRY CO., LTD., New Taipei (TW)

(72) Inventor: CHEN-HAN LIN, New Taipei (TW)

(73) Assignee: HON HAI PRECISION INDUSTRY CO., LTD., New Taipei (TW)

(21) Appl. No.: 14/257,004

(22) Filed: Apr. 21, 2014

(30) Foreign Application Priority Data
Apr. 23, 2013 (TW) 102114464

(51) Int. Cl. F21V 8/00; F21K 99/00

(52) U.S. Cl. CPC G02B 6/0045; G02B 6/0053; G02B 6/0065; F21K 9/52; G02B 6/0073; F21Y 2101/02
USPC 362/607

(57) ABSTRACT

A backlight module includes a light guide plate, a number of point light sources, and a prism sheet. The light guide plate includes a light incident surface and a light emitting surface perpendicularly connected with the light incident surface. The point light sources are positioned in front of the light incident surface. The light guide plate includes first microstructures, such as a matrix of grooves. on the light emitting surface. The prism sheet is positioned in front of the light emitting surface and includes a first surface arranged substantially parallel with the light emitting surface and a second surface opposite to the first surface. The prism sheet includes second microstructures, such as triangular prisms parallel with an intersection line of the light incident surface and the light emitting surface, on the first surface.

### FIELD

The present disclosure relates to backlight modules and, particularly, to a backlight module having point light sources.

### BACKGROUND

Light emitting diodes (LEDs) are widely used as light sources of backlight modules used in displays. A light guide is needed in the backlight module to diffuse light emitted from the LEDs to provide uniform planar illumination.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an isometric schematic view of a backlight module, according to an embodiment.

FIG. 2 is a cross-sectional schematic view of the backlight module of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

Embodiments of the present disclosure will be described with reference to the drawings.

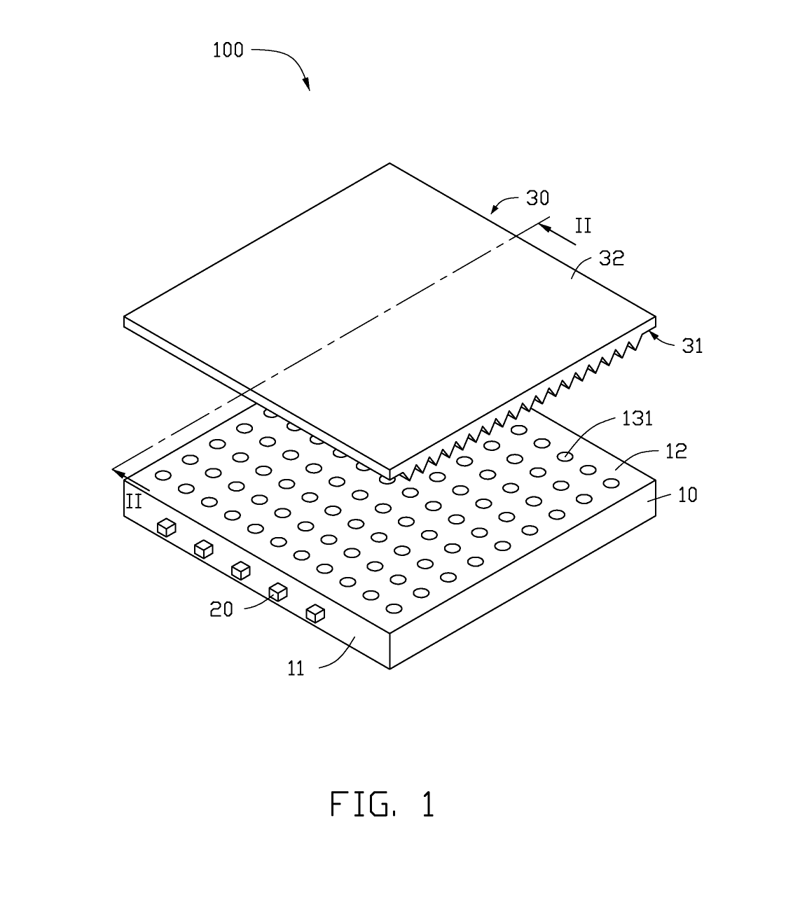

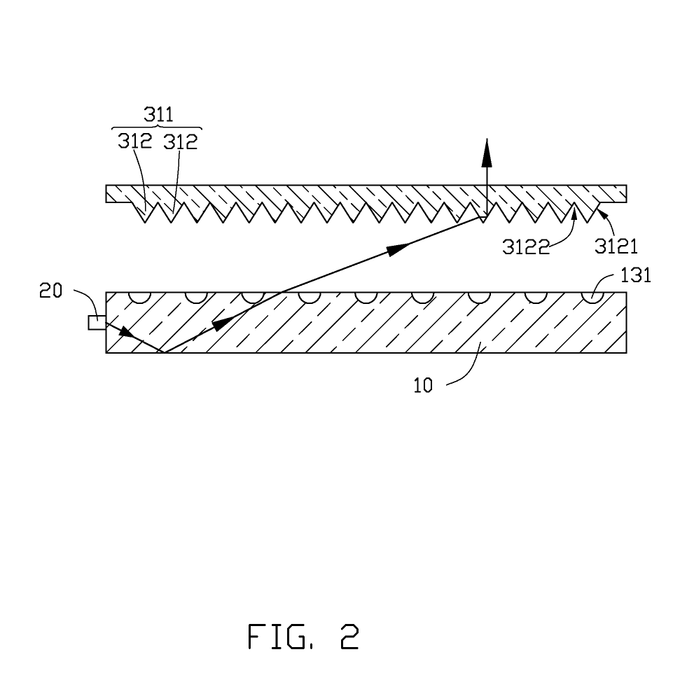

FIGS. 1-2 illustrate a backlight module 100 includes a light guide plate 10, a number of point light sources 20, and a prism sheet 30.

The light guide 10 can be made of transparent material such as polycarbonate (PC), polymethyl methacrylate (PMMA), methyl methacrylate, styrene copolymer (MS), polyethylene terephthalate (PETG), polystyrene (PS) or any compound thereof

The light guide plate 10 is generally rectangular and includes a light incident surface 11 and a light emitting surface 12 perpendicularly connected with the light incident surface 11. The light guide plate 10 is configured for guiding light from the light incident surface 11 to the light emitting surface 12. In this embodiment, the light incident surface 11 is a side surface of the light guide plate 10 and the light emitting surface 12 is a top surface of the light guide plate 10.

The light guide plate 10 includes first microstructures for light diffusion on the light emitting surface 12. In this embodiment, the first microstructures are semispherical recesses 131 arranged in a matrix. A diameter of an opening of the recesses 131 on the light emitting surface 12 falls in a range from about 1 micron to about 100 microns. A distance between each two adjacent recesses 131 falls in a range from about 1 micron to about 100 microns.

A configuration of the first microstructures is not limited to this embodiment, for example, in other embodiments, the groove 131 can have an oval shape for a more efficient diffusion.

The point light sources 20 can be LEDs or laser diodes and may be linearly and equidistantly arranged in front of the light incident surface 11. The point light sources 20 can be substantially arranged along a direction that is substantially parallel with the light emitting surface 11 and the light emitting surface 12 can be configured to emit light to the light incident surface 11.

In other embodiments, to increase efficiency, the light incident surface can also have microstructures for additionally diffusing the light from the point light sources 20.

Other side surfaces of the light guide plate 10 can function as a light incident surface and can be coupled with additional point light sources for increasing illumination brightness of the backlight module 10.

The prism sheet 30 can be rectangular and can include a first surface 31 and a second surface 32 opposite to the first surface 31. The prism sheet 30 can be arranged such that the first surface 31 can be substantially parallel with and directly face the light emitting surface 12, and can include second microstructures 311 formed on the first surface 31.

In this embodiment, the second microstructures 311 can include a number of triangular prisms 312 protruding up from the first surface 31 and arranged in parallel with an intersection line of the light emitting surface 11 and the light emitting surface 12.

Each triangular prism 312 can include a first side surface 3121 connected with the first surface 31, and a second side surface 3122 connected between the first side surface 3121 and the first surface 31. A cross-section of the triangular prism 312 can be an isosceles triangle. An included angle between the first side surface 3121 and the second side surface 3122 can fall into a range from about 60 degrees to about 70 degrees. An intersection line of the first side surface 3121 and the second side surface 3122 can be substantially parallel with the first surface 31. A height H of each triangular prism 312 from the first surface 31 falls into a range from about 1.3 microns to about 5.5 microns.

The second surface 32 can also have microstructures to increase light diffusion efficiency.

Experimental results show that a light exit angle of the backlight module 100 can be larger than that of conventional backlight modules and a uniformity of light within the light exit angle can be higher than that of the conventional backlight modules.

It will be understood that the above particular embodiments are shown and described by way of illustration only. The principles and the features of the present disclosure may be employed in various and numerous embodiments thereof without departing from the scope of the disclosure. The above-described embodiments illustrate the possible scope of the disclosure but do not restrict the scope of the disclosure.

What is claimed is:

1. A backlight module, comprising;
a light guide plate having a light incident surface and a light emitting surface perpendicularly connected with the light incident surface;
a plurality of point light sources positioned in front of the light incident surface and configured for emit light to the light incident surface, the light guide plate being configured for directing the light from the light incident surface to the light emitting surface, the light guide plate comprising first microstructures on the light emitting surface, the first microstructures comprising a matrix of grooves defined in the light emitting surface; and
a prism sheet positioned in front of the light emitting surface and comprising a first surface arranged substantially parallel with the light emitting surface and a second surface opposite to the first surface, the prism sheet comprising second microstructures on the first surface, the second microstructures comprising a plurality of triangular prisms protruding up from the first surface and arranged in parallel with an intersection line of the light incident surface and the light emitting surface.

2. The backlight module of claim 1, wherein the light guide is made of a material selected from the group consisting of polycarbonate, polymethyl methacrylate, methyl methacrylate, styrene copolymer, polyethylene terephthalate, polystyrene and any compound thereof

3. The backlight module of claim 1, wherein the first microstructures are semispherical recesses arranged in a matrix.

4. The backlight module of claim 3, wherein a diameter of an opening of the recesses on the light emitting surface falls in a range from about 1 micron to about 100 microns.

5. The backlight module of claim 3, wherein a distance between each two adjacent recesses falls in a range from about 1 micron to about 100 microns.

6. The backlight module of claim 1, wherein the point light sources are selected from the group consisting of light emitting diodes and laser diodes.

7. The backlight module of claim 1, wherein the point light sources are equidistantly arranged along a direction that is substantially parallel with the light emitting surface and the light emitting surface.

8. The backlight module of claim 1, wherein the second microstructures comprise a number of triangular prisms protruding up from the first surface and arranged in parallel with an intersection line of the light emitting surface and the light emitting surface.

9. The backlight module of claim 8, wherein a cross-section of each of the triangular prisms is an isosceles triangle.

10. The backlight module of claim 8, wherein each triangular prism comprises a first side surface connected with the first surface, and a second side surface connected between the first side surface and the first surface, and an included angle between the first side surface and the second side surface falls into a range from about 60 degrees to about 70 degrees.

11. The backlight module of claim 8, wherein each triangular prism comprises a first side surface connected with the first surface, and a second side surface connected between the first side surface and the first surface, an intersection line of the first side surface and the second side surface is substantially parallel with the first surface, and a height of each triangular prism from the first surface falls into a range from about 1.3 microns to about 5.5 microns.
